(19) United States
(12) Patent Application Publication
(10) Pub. No.: US 2007/0111752 A1
(43) Pub. Date: May 17, 2007

(54) Mobile station, anchor call server, and method for conducting a call

(76) Inventor: Rajesh S. Pazhyannur, Lake Zurich, IL (US)

Correspondence Address: MOTOROLA, INC., 1303 EAST ALGONQUIN ROAD, IL01/3RD, SCHAUMBURG, IL, 60196, US

(21) Appl. No.: 11/274,531

(22) Filed: Nov. 15, 2005

(51) Int. Cl. H04M 1/00

(52) U.S. Cl. 455/552.1

(57) ABSTRACT

A method and a system for conducting a call between a mobile station and a callee over a first wireless network and a second wireless network are provided. A call is initiated through an anchor call server when a first wireless network services the mobile station. The call comprises a first call leg between the anchor call server and the mobile station through the first wireless network, and a second call leg between the anchor call server and the callee. The mobile station detects the presence of a second wireless network when it moves into a service area of the second wireless network. A third call leg is now established between the anchor call server and the mobile station through the second wireless network. Once the third call leg is established, the first call leg is disconnected.

### FIELD OF THE INVENTION

This invention generally relates to conducting a call over wireless networks, and more specifically towards the transfer of calls from one wireless network to another.

### BACKGROUND OF THE INVENTION

With the increasing popularity of communication devices, service providers have introduced a variety of services. To make these services available to users, service providers use a variety of network technologies. The particular network technology used generally depends upon the type of service being offered, and its technical requirement, e.g. the bandwidth required. Service providers have also implemented the capability of providing similar services over different network technologies, including cellular networks, as well as packet based networks, such as wireless LANs (WLANs). A user might wish to use one or the other type of network technology. As an example, voice calls made over a WLAN may be chargeable at a lower tariff rate than those made over cellular networks. Due to such differences, the user might wish to use a WLAN when available. Existing systems allow a call originating in a WLAN to be terminated in either cellular networks or WLANs. However, a call originating in cellular networks cannot be terminated in WLANs. This is because a call originating in the cellular network communicates with a cellular network call server only, and does not go through a WLAN call server.

### BRIEF DESCRIPTION OF THE DRAWINGS

Various embodiments will hereinafter be described in conjunction with the appended drawings provided to illustrate and not to limit the invention, wherein like designations denote like elements, and in which:

FIG. 1 illustrates an exemplary environment in which various embodiments of the present invention can be practiced.

FIG. 2 illustrates an exemplary environment depicting the movement of a mobile station from a first wireless network into a service area of a second wireless network, in accordance with an embodiment of the present invention.

FIG. 3 depicts a call flow diagram for conducting a call between a mobile station and a callee, in accordance with an embodiment of the present invention.

FIG. 4 is a flowchart depicting a method for conducting a call between a mobile station and a callee, in accordance with an embodiment of the present invention.

FIG. 5 depicts a block diagram of a mobile station capable of operating in a first wireless network and a second wireless network, in accordance with an embodiment of the present invention.

FIG. 6 depicts a block diagram of an anchor call server capable of operation in a first wireless network and a second wireless network, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE EMBODIMENTS

Various embodiments of the present invention provide a method for conducting a call between a mobile station and a callee over a first wireless network and a second wireless network. The mobile station is capable of operating in the first wireless network and the second wireless network. A call is initiated through an anchor call server when the mobile station is connected to the first wireless network. The call comprises a first call leg between the anchor call server and the mobile station through the first wireless network, and a second call leg between the anchor call server and the callee. When the mobile station moves into a service area of the second wireless network, the mobile station detects the presence of the second wireless network. A third call leg is established between the anchor call server and the mobile station through the second wireless network. Once the third call leg is established, the first call leg is disconnected.

Various embodiments of the invention also provide a mobile station capable of operating in a first wireless network and a second wireless network. The mobile station communicated with an anchor call server. The mobile station comprises a transceiver, a detector and a processor. The transceiver initializes a call between the mobile station and a callee through the anchor call server. The detector is responsible for detecting the presence of the second wireless network. When the second wireless network is present, the processor hands off the call from the first wireless network to the second wireless network.

Various embodiments of the invention also provide an anchor call server capable of operation in a first wireless network and a second wireless network. The anchor call server comprises a transceiver, a calling module and a handoff module. The transceiver communicates with a mobile station. The calling module is capable of initiating a first call leg between the anchor call server and the mobile station through the first wireless network. The calling module is also capable of initiating a second call leg between the anchor call server and a callee. The handoff module is capable of disconnecting the first call leg and initializing a third call leg between the anchor call server and the mobile station through the second wireless network.

Before describing in detail the method for conducting a call between a mobile station and a callee over a first wireless network and a second wireless network, it should be observed that the present invention resides primarily in the method steps and apparatus components, which are employed to conduct the call between the mobile station and the callee.

Accordingly, the method steps and apparatus components have been represented where appropriate by conventional symbols in the drawings, showing only those specific details that are pertinent to understanding the present invention, so as not to obscure the disclosure with details that will be readily apparent to those of ordinary skill in the art having the benefit of the description herein.

In this document, relational terms such as first and second, and so forth may be used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including” and/or “having”, as used herein, are defined as comprising.

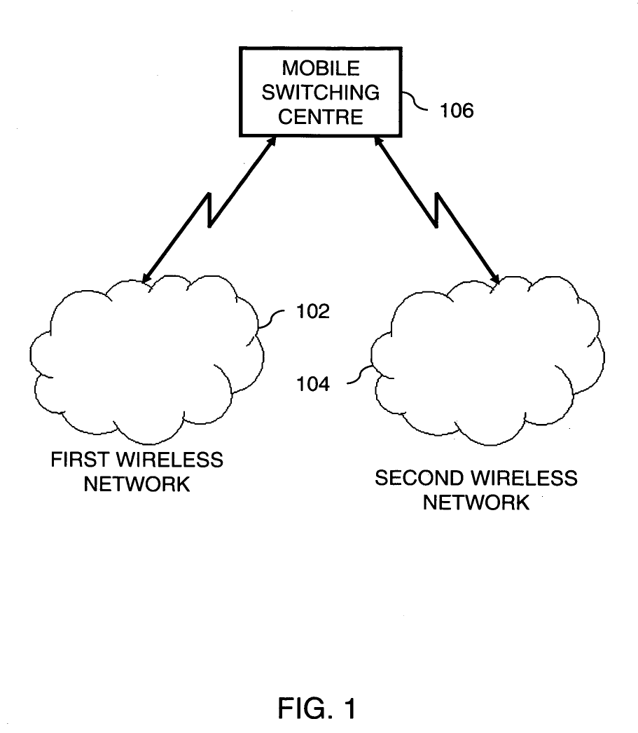

FIG. 1 illustrates an exemplary environment in which various embodiments of the present invention can be practiced. The environment 100 includes a first wireless network 102 communicating with a second wireless network 104 through a mobile switching centre (MSC) 106. The MSC 106 enables data to reach its intended destination in the wireless networks by switching the data to an appropriate route. In an exemplary embodiment of the present invention, the first wireless network 102 is a cellular network and the second wireless network 104 is a packet switched network.

Examples of the first wireless network 102 in which the mobile station 202 can operate, include, but are not limited to, an Advanced Mobile Phone System (AMPS) network, a Narrowband Advanced Mobile Phone System (N-AMPS) network, a Cellular Digital Packet Data (CDPD) network, a Global System for Mobile communications (GSM) network, a Code Division Multiple Access (CDMA) network, a Wideband Code Division Multiple Access (W-CDMA) network, a Time Division Multiple Access (TDMA) network, a Universal Mobile Telephone Service (UMTS) network, an Integrated Digital Enhanced Network (iDEN), a Specialized Mobile Radio (SMR) network and an Enhanced Specialized Mobile Radio (ESMR) network.

Examples of the second wireless network 104 in which the mobile station 202 can operate, include, but are not limited to, an Internet Protocol (IP) network, a Transmission Control Protocol (TCP) network, a Transmission Control Protocol/Internet Protocol (TCP/IP) suite network, an X.25 protocol network, an Internet Packet Exchange (IPX) network, a Sequenced Packet Exchange (SPX) network, a Global System for Mobile communications-General Packet Radio Service (GSM-GPRS) network, a Global System for Mobile communications-Enhanced Data Rates for GSM Evolution (GSM-EDGE) network, a Code Division Multiple Access-International Mobile Telecommunications-2000 (CDMA IMT2000) network and a User Datagram Protocol (UDP) network.

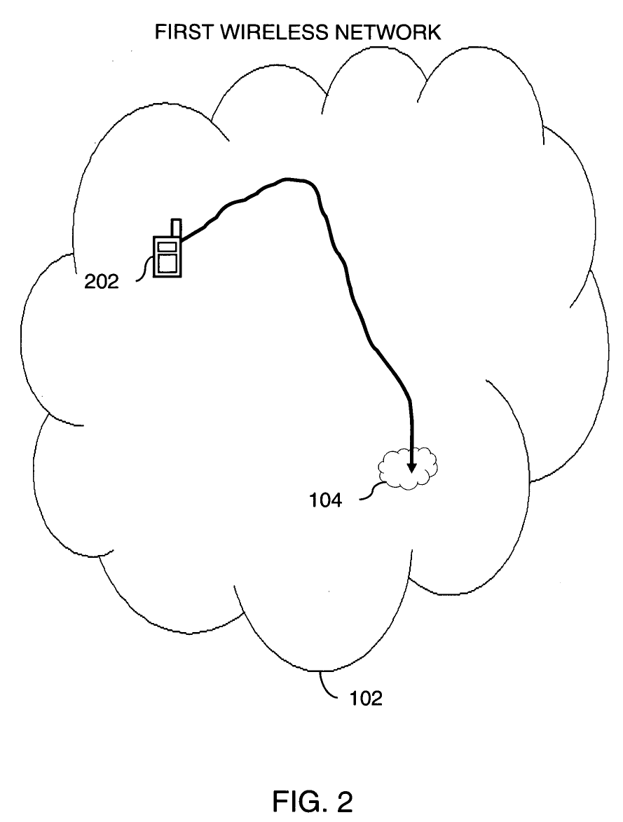

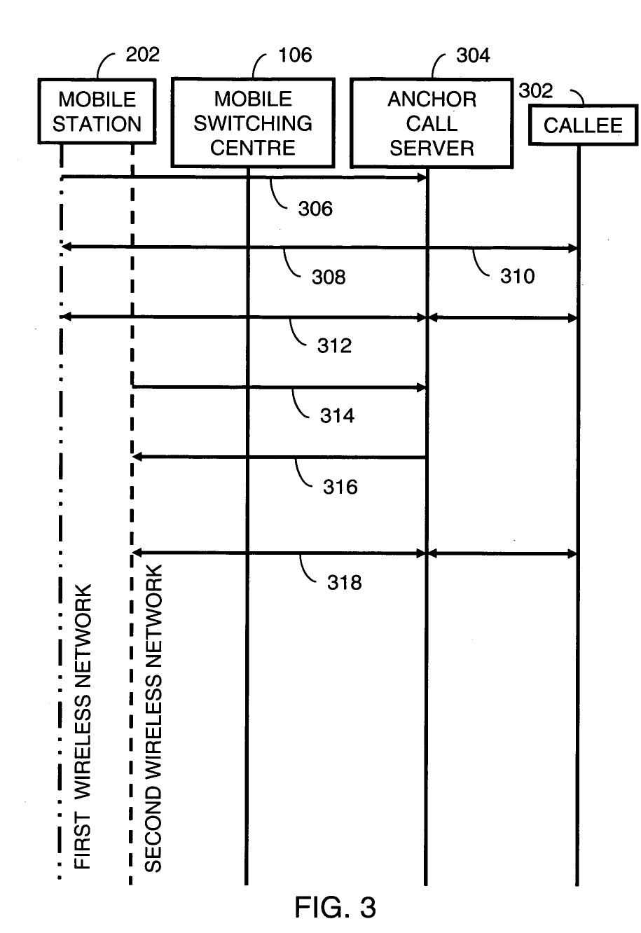

FIG. 2 illustrates an exemplary environment depicting the movement of a mobile station 202 into a service area of the second wireless network 104, in accordance with an embodiment of the present invention. The service area of a packet switched wireless network is typically much smaller than that of a cellular network. Therefore, the second wireless network 104 is shown to lie within the first wireless network 102. The mobile station 202 moves into the service area of the second wireless network 104 while remaining in the service area of the first wireless network 102. The mobile station 202 can communicate through both the first wireless network 102 and the second wireless network 104. Further, when the mobile station 202 enters the service area of the second wireless network 104, a call initiated by the mobile station 202 through the first wireless network 102 to a callee, can be handed off to the second wireless network 104. The callee can be within any wireless network. The call flow that can be utilized to achieve this hand off from the first wireless network 102 to the second wireless network 104 is described in conjunction with FIG. 3.

FIG. 3 depicts a call flow diagram for conducting a call between the mobile station 202 and a callee 302, in accordance with an embodiment of the present invention. For the establishment of a call over the second wireless network 104, and hand over of the call from the first wireless network 102 to the second wireless network 104, the mobile station 202 sends a call origination request 306 to an anchor call server 304 through the mobile switching center 106. The call origination request 306 is a communication to the anchor call server 304, and includes information such as an identifier for the mobile station 202 and an identifier for the callee 302. The identifiers can be, for example, the phone numbers for the mobile station 202 and the callee 302. The identifiers enable the anchor call server 304 to act as a third party call control (3PCC) server. The call origination request 306 can be sent by the mobile station 202 utilizing a Short Messaging Service (SMS) message, an Advanced Intelligent Network (AIN) based Intelligent Network (IN) trigger, or any other equivalent technique that is capable of transmitting the required information to the anchor call server 304. In response to the call origination request 306, the anchor call server 304 originates a first call leg 308 by calling the mobile station 202 through the first wireless network 102 and a second call leg 310 by calling the callee 302. The anchor call server 304 then couples the first call leg 308 with the second call leg 310. An end-to-end call 312 is then established. During the call, the anchor call server 304 operates in a Back to Back User Agent (B2BUA) mode. This means that the anchor call server 304 acts as a bearer path server and a signaling path server for the mobile station 202 and the callee 302. [For the inventors: Please confirm the above understanding.]

When the mobile station 202 moves into the service area of the second wireless network 104, the availability of the second wireless network 104 is detected and communicated to the anchor call server 304. The mobile station 202 sends a handoff request 314 to the anchor call server 304 to hand off the call to the second wireless network 104. In response to the handoff request 314, the anchor call server 304 originates a third call leg 316 by calling the mobile station 202 through the second wireless network 104. Once the third call leg 316 is established, the anchor call server 304 disconnects the first call leg 308. Therefore, a new end-to-end call 318 is established. The new end-to-end call 318 comprises the third call leg 316 and the second call leg 310. The mobile station 202 continues to communicate with the callee 302 seamlessly over the new end-to-end call 318, retaining connectivity through the handoff.

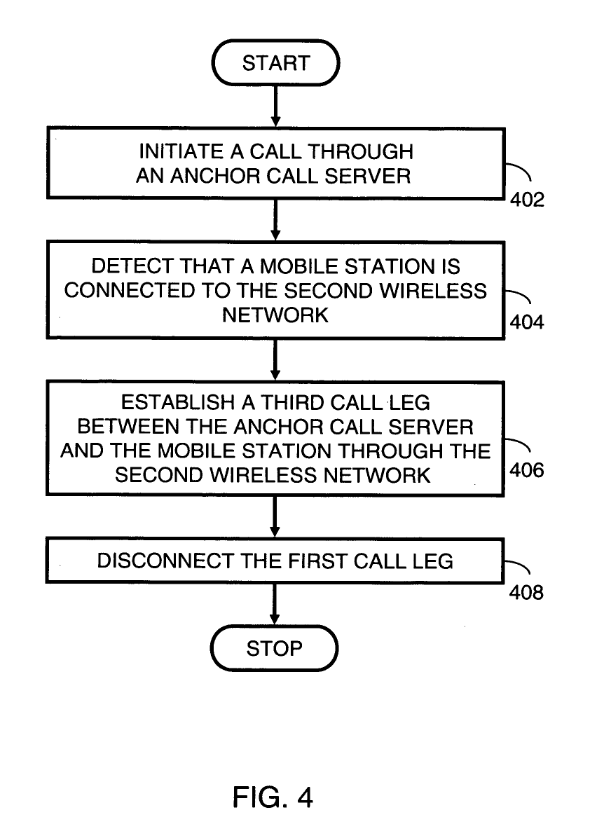

FIG. 4 is a flowchart depicting a method for conducting a call between a mobile station and a callee, in accordance with one embodiment of the present invention. At step 402, the mobile station initiates a call to a callee through an anchor call server by sending a call origination request to the anchor call server. At the time of origination of the call, the mobile station is in the service area of a first wireless network. The call comprises a first call leg connecting the anchor call server to the mobile station, and second call leg connecting the anchor call server to the callee. When the mobile station moves into the service area of a second wireless network, it detects that the mobile station is connected to the second wireless network, at step 404. The mobile station communicates the availability of the second wireless network to the anchor call server. At step 406, the anchor call server establishes a third call leg between the anchor call server and the mobile station through the second wireless network. At step 408, once the third call leg has been established, the anchor call server disconnects the first call leg, and continues the end-to-end call over the second call leg and the third call leg. This handoff is seamless, and there is no disruption of the end-to-end call during handoff. This third party call control server functionality is enabled by the presence of the anchor call server in the call-path of the communication.

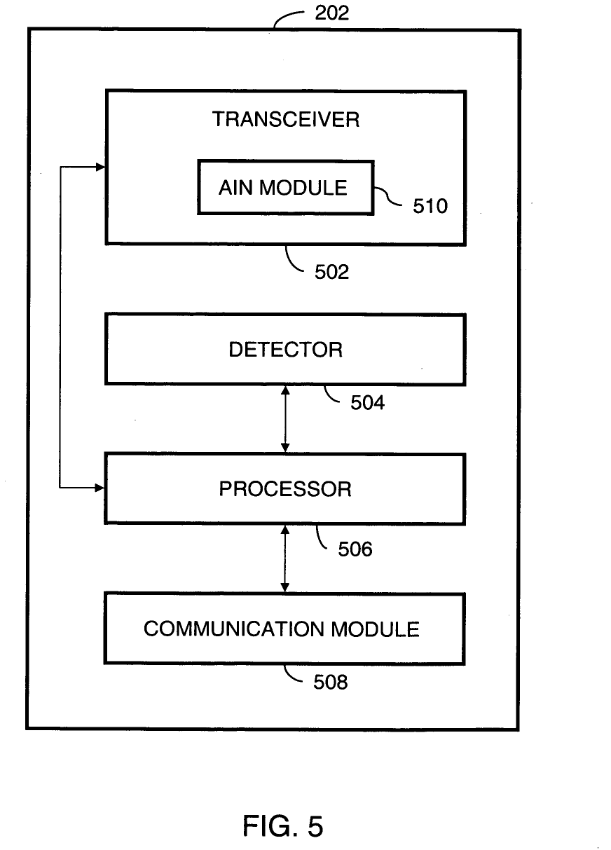

FIG. 5 depicts a block diagram of the mobile station 202 capable of operating in the first wireless network 102 and the second wireless network 104, in accordance with an embodiment of the present invention. The mobile station 202 includes a transceiver 502, a detector 504 and a processor 506. The transceiver 502 establishes calls between the mobile station 202 and the callee 302 through the anchor call server 304 and is responsible for sending and receiving signals during the call. To initiate the call, a communication module 508 can send information regarding the mobile station 202 and the callee 302 to the anchor call server 304. In an embodiment of the present invention, the transceiver 502 includes an Advanced Intelligent Network (AIN) module 510 for communicating with the anchor call server through an AIN. The mobile station 202 utilizes at least one of a Short Messaging Service (SMS) and an Advanced Intelligent Network (AIN) based Intelligent Network (IN) trigger to initiate the call between the mobile station 202 and the callee 302. The mobile station 202 communicates the availability of the second wireless network 104 when the detector 504 detects the availability. The availability of the second wireless network 104 is communicated to the anchor call server 304 when it is detected. The mobile station 202 communicates this to the anchor call server 304 by sending a message through the second wireless network 104. In an alternate embodiment of the present invention, the mobile station 202 can also communicate the availability of the second wireless network 104 to the anchor call server 304 by sending a message through the first wireless network 102. Once the third call leg is established, the processor 506 of the mobile station 202 requests the anchor call server 304 to handoff the end-to-end call to the second wireless network 104.

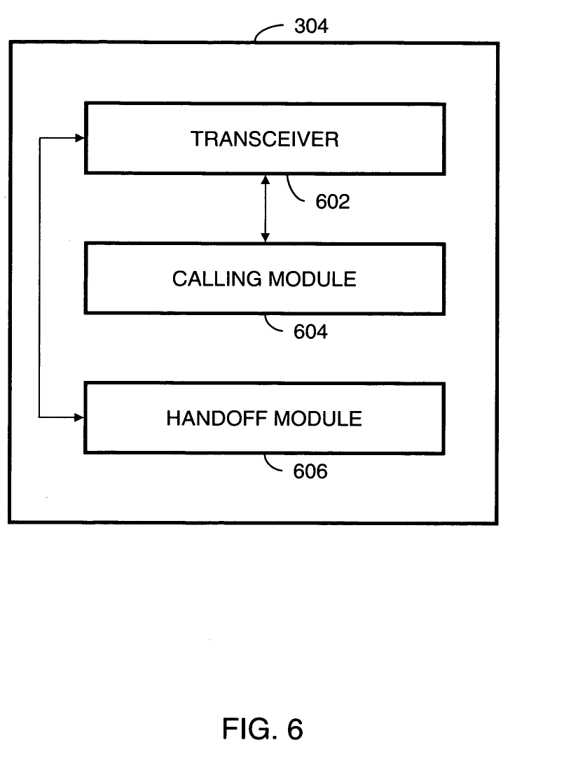

FIG. 6 depicts a block diagram of the anchor call server 304 capable of operation in a first wireless network and a second wireless network, in accordance with an embodiment of the present invention. The anchor call server 304 is capable of operating as a third party call control (3PCC) server. The anchor call server 304 includes a transceiver 602, a calling module 604, and a handoff module 606. The transceiver 602 is utilized to communicate with the transceiver 502 of the mobile station 202 and the callee 302. The calling module 604 establishes call legs between the anchor call server 304, and the mobile station 202 and the callee 302. Once the third call leg has been established, the handoff module 606 communicates with processor 506, and hands off the call from the first wireless network 102 to the second wireless network 104. In accordance with an embodiment of the invention, the call legs are initiated using a procedure defined by the Session Initiation Protocol (SIP) standard. Further details regarding the initiation can be obtained from Request for Comments (RFC) 3725, titled ‘Best Current Practices for Third Party Call Control (3pcc) in Session Initiation Protocol (SIP)’, published by the Internet Engineering Task Force, in April 2004.

Various embodiments of the present invention provide a mobile station, an anchor call server, and a method for conducting a call between a mobile station and a callee. The mobile station can switch from using the first wireless network to the second wireless network when it enters the coverage area of the second wireless network. The call is handed over seamlessly to the second wireless network, and there is no disruption of end-to-end connectivity. Since the cost of communicating over the second wireless network is less than that of the first wireless network, the overall cost incurred by a user of the mobile station can be reduced. Further, this ability to hand off calls between wireless networks enables network service providers to introduce flexible service plans.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for conducting a call between a mobile station and a callee, the mobile station being capable of operation in a first wireless network and a second wireless network, the method comprising:
initiating the call through an anchor call server when the mobile station is connected to the first wireless network, wherein the call comprises a first call leg between the anchor call server and the mobile station through the first wireless network, and a second call leg between the anchor call server and the callee;
detecting that the mobile station is connected to the second wireless network;
establishing a third call leg between the anchor call server and the mobile station through the second wireless network; and
disconnecting the first call leg.

2. The method according to claim 1 further comprising operating the anchor call server as a third party call control server.

3. The method according to claim 1, wherein the anchor call server acts as a bearer path server and a signalling path server for the mobile station and the callee.

4. The method according to claim 1, wherein initiating the call comprises:
sending a call origination request to the anchor call server, the call origination request being sent by the mobile station utilizing at least one of a Short Messaging Service (SMS) message and an Advanced Intelligent Network (AIN) based Intelligent Network (IN) trigger.

5. The method according to claim 1, wherein initiating the call further comprises:
receiving a call origination request at the anchor call server, the call origination request being sent by the mobile station utilizing at least one of a Short Messaging Service (SMS) message and an Advanced Intelligent Network (AIN) based Intelligent Network (IN) trigger.

6. The method according to claim 1, wherein establishing the third call leg comprises:
communicating an availability of the second wireless network to the anchor call server.

7. The method according to claim 1, wherein disconnecting the first call leg comprises:
sending a handoff request to the anchor call server in response to detecting the second wireless network; and
continuing the call through the third call leg.

8. The method according to claim 1, wherein the first wireless network is a cellular network and the second wireless network is a packet switched network.

9. A mobile station capable of operating in a first wireless network and a second wireless network, the mobile station communicating with an anchor call server, the mobile station comprising:
a transceiver for initializing a call between the mobile station and a callee through the anchor call server;
a detector for detecting the availability of the second wireless network; and
a processor for handing off the call to the second wireless network.

10. The mobile station according to claim 9, further comprising:
a communication module capable of sending information regarding the mobile station and a callee to the anchor call server.

11. The mobile station according to claim 9, wherein the transceiver comprises:
an Advanced Intelligent Network (AIN) module for communicating with the anchor call server through an AIN.

12. The mobile station according to claim 9, wherein the transceiver utilizes at least one of a Short Messaging Service (SMS) and an Advanced Intelligent Network (AIN) based Intelligent Network (IN) trigger for initializing the call through the anchor call server.

13. The mobile station according to claim 9, wherein the first wireless network is a cellular network and the second wireless network is a packet switched network.

14. The mobile station according to claim 13, wherein the cellular network is at least one network selected from a group comprising an Advanced Mobile Phone System (AMPS) network, a Narrowband Advanced Mobile Phone System (N-AMPS) network, a Cellular Digital Packet Data (CDPD) network, Global System for Mobile communications (GSM) network, a Code Division Multiple Access (CDMA) network, a Wideband Code Division Multiple Access (W-CDMA) network, a Time Division Multiple Access (TDMA) network, a Universal Mobile Telephone Service (UMTS) network, an Integrated Digital Enhanced Network (iDEN), a Specialized Mobile Radio (SMR) network and an Enhanced Specialized Mobile Radio (ESMR) network.

15. The mobile station according to claim 13, wherein the packet switched network is at least one network selected from a group comprising an Internet Protocol (IP) network, a Transmission Control Protocol (TCP) network, a Transmission Control Protocol/Internet Protocol (TCP/IP) suite network, an X.25 protocol network, an Internet Packet Exchange (IPX) network, a Sequenced Packet Exchange (SPX) network, a Global System for Mobile communications-General Packet Radio Service (GSM-GPRS) network, a Global System for Mobile communications-Enhanced Data Rates for GSM Evolution (GSM-EDGE) network, a Code Division Multiple Access-International Mobile Telecommunications-2000 (CDMA IMT2000) network and a User Datagram Protocol (UDP) network.

16. An anchor call server capable of operation in a first wireless network and a second wireless network, the anchor call server comprising:
a transceiver for communicating with a mobile station;
a calling module for initiating a first call leg between the anchor call server and the mobile station through the first wireless network and a second call leg between a callee and the anchor call server; and
a handoff module for disconnecting the first call leg and initializing a third call leg between the anchor call server and the mobile station through the second wireless network.

17. The anchor call server according to claim 16, wherein the anchor call server is capable of operating as a third party call control server.

18. The anchor call server according to claim 16, wherein the first wireless network is a cellular network and the second wireless network is a packet switched network.

19. The anchor call server according to claim 18, wherein the cellular network is at least one network selected from a from a group comprising an Advanced Mobile Phone System (AMPS) network, a Narrowband Advanced Mobile Phone System (N-AMPS) network, a Cellular Digital Packet Data (CDPD) network, a Global System for Mobile communications (GSM) network, a Code Division Multiple Access (CDMA) network, a Wideband Code Division Multiple Access (W-CDMA) network, a Time Division Multiple Access (TDMA) network, a Universal Mobile Telephone Service (UMTS) network, an Integrated Digital Enhanced Network (iDEN), a Specialized Mobile Radio (SMR) network and an Enhanced Specialized Mobile Radio (ESMR) network.

20. The anchor call server according to claim 18, wherein the packet switched network is at least one network selected from a group comprising an Internet Protocol (IP) network, a Transmission Control Protocol (TCP) network, a Transmission Control Protocol/Internet Protocol (TCP/IP) suite network, an X.25 protocol network, an Internet Packet Exchange (IPX) network, a Sequenced Packet Exchange (SPX) network, a Global System for Mobile communications-General Packet Radio Service (GSM-GPRS) network, a Global System for Mobile communications-Enhanced Data Rates for GSM Evolution (GSM-EDGE) network, a Code Division Multiple Access-International Mobile Telecommunications-2000 (CDMA IMT2000) network and a User Datagram Protocol (UDP) network.
